(19) United States
(12) Patent Application Publication
(10) Pub. No.: US 2010/0126477 A1
(43) Pub. Date: May 27, 2010

(54) EVAPORATIVE EMISSIONS CONTROL SYSTEM

(75) Inventor: Sam R. Reddy, West Bloomfield, MI (US)

Correspondence Address: CICHOSZ & CICHOSZ, PLLC, 129 E. COMMERCE, MILFORD, MI, 48381, US

(73) Assignee: GM GLOBAL TECHNOLOGY OPERATIONS, INC., DETROIT, MI (US)

(21) Appl. No.: 12/275,287

(22) Filed: Nov. 21, 2008

(51) Int. Cl. F02M 33/04; F02M 33/02

(52) U.S. Cl. 123/520; 123/519

(57) ABSTRACT

A sealable fuel vapor storage and recovery system includes a sealable fuel tank and a vapor storage device. The vapor storage device includes a first end, a chamber and a second end defining a linear flow path. A vent valve is selectively controllable to one of an open position and a closed position and imposes substantially no flow restriction.

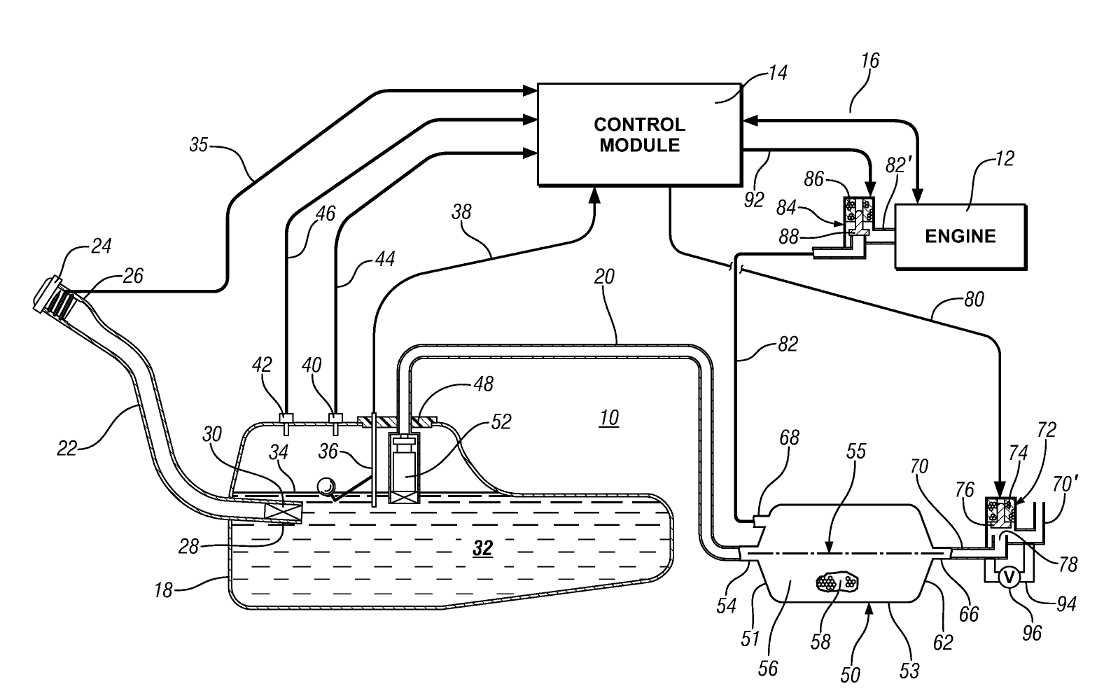

### TECHNICAL FIELD

This disclosure is related to evaporative emissions control systems.

### BACKGROUND

The statements in this section merely provide background information related to the present disclosure and may not constitute prior art.

Evaporative emissions control systems are used to capture and contain fuel vapors generated in fuel tanks of vehicles and stationary storage systems. Known systems include vapor storage devices connected via vapor lines to a fuel tank. Known systems include vapor storage devices having a vent line connectable to atmospheric air and a purge line connectable to a vacuum source, e.g., an intake manifold of an internal combustion engine.

Fuel vapor can be generated in the fuel storage tank and stored in the vapor storage device ongoingly, including fuel vapor generated due to variations in ambient temperature over time, referred to as diurnal fuel vapor. Stored fuel vapor can be purged from the vapor storage device by air flow through the vapor storage device, e.g., when low pressure is introduced to the purge line and air is drawn through the vapor storage device through the vent line. In some applications, e.g., a hybrid vehicle using a plug-in electric charging system, a fuel tank may generate diurnal fuel vapors for storage in the vapor storage device, and purging of the fuel vapor stored in the vapor storage device may not occur for an extended time period. If the vapor storage device is not purged, the vapor storage device may saturate and release any subsequently produced fuel vapor into the atmosphere.

### SUMMARY

A sealable fuel vapor storage and recovery system includes a fuel tank and a vapor storage device. The vapor storage device includes a chamber containing fuel vapor adsorbent material and has a first end including first and second openings and a second end including a third opening. The first end and the chamber and the second end define a linear flow path therebetween. The first opening of the vapor storage device is fluidly connected to a vent opening in the fuel storage tank. The second opening of the vapor storage device is fluidly connected to a purge line fluidly connectable to an induction system via a purge valve. The third opening is fluidly connected to a vent valve in fluid communication with atmospheric air. The vent valve is selectively controllable to one of an open position and a closed position. The vent valve seals the third opening of the vapor storage device when controlled in the closed position and has a cross-sectional area equal to a cross-sectional area of the third opening of the vapor storage device when controlled in the open position.

### BRIEF DESCRIPTION OF THE DRAWING

One or more embodiments will now be described, by way of example, with reference to the accompanying FIGURE which is a schematic diagram of a sealable fuel vapor storage and recovery system in accordance with the present disclosure.

### DETAILED DESCRIPTION

Referring now to the FIGURE, wherein the showing is for the purpose of illustrating certain exemplary embodiments only and not for the purpose of limiting the same, an embodiment of a sealable fuel vapor storage and recovery system 10 is shown. The illustration is schematic and the components are not drawn to scale. The sealable fuel vapor storage and recovery system 10 is depicted as an element of a system that includes an internal combustion engine 12 and a control module 14 in the embodiment. The sealable fuel vapor storage and recovery system 10 can be applied to a motor vehicle employing multiple propulsion technologies, e.g., a hybrid vehicle, although the disclosure is not so limited.

The internal combustion engine 12 can include a multi-cylinder internal combustion engine that generates mechanical power by combusting fuel comprising gasoline and other combustible liquids in combustion chambers (not shown). The engine 12 is operatively controlled by the control module 14. The control module 14 preferably comprises a digital programmable device include a microprocessor that monitors input signals from sensors (not shown) and generates output signals to control actuators (not shown) to operate the engine 12 and the sealable fuel vapor storage and recovery system 10. Line 16 between the engine 12 and the control module 14 schematically depicts the flow of input signals and output signals therebetween.

The sealable fuel vapor storage and recovery system 10 includes a fuel tank 18 and a fuel vapor adsorption canister 50. During operation of the engine 12, fuel is delivered from the fuel tank 18 by a fuel pump (not shown, but often located in the fuel tank) through a fuel line (not shown) to a fuel rail and fuel injectors (not shown) that preferably supplies fuel to each cylinder of the engine 12. Operation of the fuel pump and fuel injectors is preferably managed by the control module 14.

In one embodiment, the fuel tank 18 is a blow-molded device formed using high density polyethylene having one or more interior layers that are impermeable to fuel including gasoline. A fill tube 22 is connected to the fuel tank 18, having a fill end 26 through which fuel can be poured and an outlet end 28 emptying into the fuel tank 18. A one-way valve 30 prevents liquid fuel from splashing out the fill tube 22. There is a removable fuel cap 24 that can sealably close the fill end 26. An on-board refueling vapor recovery system (hereafter ‘ORVR’) includes an ORVR signal line 35 that communicates to the control module 14 an operator request to pour fuel into the fuel tank 18 through the fill tube 22. A volume of fuel 32 is indicated with upper surface 34. A float-type fuel level indicator 36 provides a fuel level signal through line 38 to the control module 14. In one embodiment, a fuel tank pressure sensor 40 and a temperature sensor 42 generate signals transmitted to the control module 14 via lines 44 and 46, respectively. The fuel tank 18 is provided with a vent line 20 that leads through seal 48 from the top of the fuel tank 18 to the fuel vapor adsorption canister 50. A float valve 52 within the fuel tank 18 prevents liquid fuel from entering the vent line 20. Fuel vapor mixed with air can flow through the vent line 20 to a first opening 54 of the fuel vapor adsorption canister 50. Preferably, fuel vapor flows through the vent line to the fuel vapor adsorption canister 50 when fuel is poured into the fuel tank 18 through the fill tube 22 as part of on-board refueling vapor recovery.

The fuel vapor adsorption canister 50 preferably includes a body 53 comprising a closed structure molded of a fuel-impermeable thermoplastic polymer, e.g., nylon. The closed structure of the fuel vapor adsorption canister 50 includes a first end 51 including the first opening 54 and a second opening 68, and a second end 62 including a third opening 66. The first end 51, the body 53, and the second end preferably form a single chamber 56 for containing a mass of an adsorbent material 58. The fuel vapor adsorption canister 50 includes one or more granule retaining elements (not shown) to facilitate retention of the adsorbent material 58 in the single chamber 56 of the body 53. The fuel vapor adsorption canister 50 includes one or more diffusers (not shown) to diffuse vapor and airflow across a cross-section of the single chamber 56 of the body 53. The adsorbent material 58 preferably comprises an activated carbon material, e.g., activated carbon granules operative to adsorb hydrocarbon vapors passing from the fuel tank 18 and ORVR system through the vent line 20 to the first opening 54. Preferably, a first dimension of the body 53 defines a longitudinal axis 55. Preferably, the first end 51, the single chamber 56 of the body 53, and the second end 62 of the fuel vapor adsorption canister 50 are linearly arranged parallel to the longitudinal axis 55. Thus, a linear flow path is defined through the fuel vapor adsorption canister 50 between the first end 51, the single chamber 56 of the body 53, and the second end 62 substantially parallel to the longitudinal axis 55.

A first end of a vent tube 70 connects to the third opening 66 of the fuel vapor adsorption canister 50 in one embodiment. A second end 78 of the vent tube 70 connects to a vent valve 72, referred to as a diurnal control valve (hereafter ‘DCV’). The DCV 72 preferably comprises a single-stage high-flow sealable valve 76 operatively connected to a normally closed solenoid 74 that is operatively connected to the control module 14 via a control line 80. When the DCV 72 is in the closed position, the sealable valve 76 sealably closes the second end 78 of the vent tube 70. When the DCV 72 is in the open position (as shown), the second end 78 of the vent tube 70 fluidly connects to atmospheric air, including connecting to atmospheric air via a second tube 70′ in one embodiment. Preferably there is no orifice or other flow restriction device in the vent tube 70 or the second tube 70′. Preferably, inner diameters of the vent tube 70, the DCV 72 when opened, and the second tube 70′ are such that they impose minimal or substantially no restrictions to flow of air into or out of the third opening 66 of the fuel vapor adsorption canister 50 when the DCV 72 is controlled in the open position relative to any anticipated system pressure drop and associated vapor flow rate. In one embodiment, the tube 70′, the DCV 72, and the vent tube 70 each have cross-sectional flow areas that are equal to a cross-sectional flow area of the third opening 66 of the fuel vapor adsorption canister 50 when controlled in the open position to minimize flow restriction between the third opening 66 of the fuel vapor adsorption canister 50 and atmospheric air. In one embodiment (not shown) the tube 70′ is omitted, and the DCV 72 and the vent tube 70 each have cross-sectional flow areas that are equal to or larger than a cross-sectional flow area of the third opening 66 of the fuel vapor adsorption canister 50. In one embodiment (not shown) the tube 70′ and the vent tube 70 are omitted, and the DCV 72 directly fluidly connects to the third opening 66 of the fuel vapor adsorption canister 50 and has a cross-sectional flow area that defines a cross-sectional flow area of the third opening 66.

Preferably a pressure relief valve 96 is configured to provide flow around the DCV 72 via tube 94 in either an overpressure condition or an over-vacuum (or underpressure) condition. The pressure relief valve 96 protects the sealable fuel vapor storage and recovery system 10 from damage due to overpressure and over-vacuum events. In one embodiment, the pressure relief valve 96 has a positive pressure threshold at or near 25 kPa-gage, and a negative pressure threshold at or near 10 kPa-gage. The DCV 72 is normally closed (not shown), including during vehicle shutdown and during vehicle operation when the engine 12 is not operating. The DCV 72 is energized to open during refueling events and during purging events during operation of the engine 12.

The second opening 68 of the first end 51 of the fuel vapor adsorption canister 50 fluidly connects to an induction system via a purge line 82, a solenoid-actuated purge valve 84, and a second purge line 82′. The induction system comprises an intake manifold (not shown) of the engine 12 in one embodiment. The purge valve 84 includes a sealable valve 88 and a normally-closed solenoid 86 operatively connected to the control module 14 via a control line 92.

A first operating state of the sealable fuel vapor storage and recovery system 10 includes the purge valve 84 sealingly closed (as shown) and the DCV 72 sealingly closed (not shown). With the fuel cap 24 sealingly closed, the sealable fuel vapor storage and recovery system 10 is a closed system, and can experience variations in pressure caused by expansion and contraction of gases caused by temperature changes, e.g., due to diurnal temperature variations. When the DCV 72 is closed, there is no pressure differential across, and therefore no flow through, the fuel vapor adsorption canister 50. Therefore, minimal loading of the fuel vapor adsorption canister 50 occurs. The first operating state is commanded by the control module 14 under conditions including when the engine 12 is turned off and when the vehicle is commanded off.

A second operating state of the sealable fuel vapor storage and recovery system 10 includes a signal from the ORVR signal line 35 to the control module 14 indicating a refueling event, and preferably preceding opening the fuel cap 24. When the refueling signal is received across the ORVR signal line 35, the DCV 72 is commanded open by the control module 14 to facilitate flow of fuel vapor and air through the fuel vapor adsorption canister 50 during refueling and ORVR operation due to a pressure drop across the fuel vapor adsorption canister 50. The purge valve 84 remains sealingly closed during this operating state. The DCV 72 can be opened when the fuel tank 18 is pressurized, causing tank vapors to vent into the fuel vapor adsorption canister 50. The volume of vented vapor into the fuel vapor adsorption canister 50 is directly proportional to tank vapor space volume. A nearly empty fuel tank generates and vents a larger volume of vapor compared to a nearly full fuel tank. The adsorption status of the fuel vapor adsorption canister 50, i.e., one of being purged or being loaded with refueling vapors, is a function of fuel level in the fuel tank. A nearly empty fuel tank 18 indicates a fully purged fuel vapor adsorption canister 50 because the engine 12 has previously operated for a period of time sufficient to consume fuel, including purging fuel vapor stored therein. Subsequently, the purged fuel vapor adsorption canister 50 has a vapor storage capacity sufficient to adsorb fuel vapor vented from the pressurized fuel tank.

A third operating state of the sealable fuel vapor storage and recovery system 10 includes purging the fuel vapor adsorption canister 50, in one embodiment by operating the engine 12. During purging, e.g., during engine operation, the DCV 72 is controlled to the open position, and the purge valve 84 is opened (not shown), creating a flow path between the tube 70′, through the DCV 72 and the fuel vapor adsorption canister 50 through the second opening 68 to purge line 82 through the solenoid-actuated purge valve 84. In one embodiment, the flow path to the intake manifold of the engine 12 is due to a pressure drop caused by engine operation. Flow of air through the fuel vapor adsorption canister 50 purges the adsorbed fuel which can be ingested and burned in the engine 12 during engine operation. The DCV 72 seals the third opening 66 of the fuel vapor adsorption canister 50 when controlled in the closed position.

A sealable fuel vapor storage and recovery system was constructed in accordance with an embodiment of the disclosure to simulate operation of the sealable fuel vapor storage and recovery system 10 including operating in the second operating state described herein. Evaporative emissions tests were conducted using a rectangularly-shaped steel fuel tank having a total volume of 108 liters (29 gal.) filled with 54 liters (14 gal.) of fuel having a Reid Vapor Pressure (‘RVP’) of 50 kPa (7 psi) fuel at 24° C. (75° F.). The fuel tank was pressurized to 15 kPa-gage pressure by pumping air into the tank. The pressure was released into the first end 51 of the fuel vapor adsorption canister 50 constructed as described herein having a linear flow path, with the DCV 72 controlled in the open position. Breakthrough emissions were measured in a test cell referred to as a SHED (‘Sealed Housing for Evaporative Determination) enclosure. The second tube 70′ connected to the DCV 72 was fitted with flow restriction orifices having various diameters. Table 1 shows results of the emissions tests, comprising breakthrough emissions, in mg HC, corresponding to a diameter of the flow restriction orifice. A corresponding elapsed period of time for pressure to bleed down from 15 kPa to 1.5 kPa is shown for each flow restriction orifice. The results indicate that breakthrough emissions increased with decrease in orifice diameter size, which is opposite of what was expected.

TABLE 1

| | Breakthrough | Time for Pressure Bleed |
|---|---|---|
| | Emissions, | Down to 1.5 kPa, |
| Orifice, mm | mg | Sec |
| 9 | 331 | 1.6 |
| 6.7 | 361 | 2.8 |
| 4 | 424 | 7.7 |
| 0.5 | 945 | 500 |

The larger diameter orifices result in higher vapor flow rates through the fuel vapor adsorption canister 50 during an on-board refueling event causing increased fluid turbulence and improved surface contact between the fuel vapors and carbon particles of the adsorbent material 58. There is increased hydrocarbon adsorption and lower breakthrough emissions with increased orifice size, i.e., decreased flow restriction between the third opening 66 to the vapor storage device 50 and atmospheric air when operating in the second operating state during on-board refueling.

The disclosure has described certain preferred embodiments and modifications thereto. Further modifications and alterations may occur to others upon reading and understanding the specification. Therefore, it is intended that the disclosure not be limited to the particular embodiment(s) disclosed as the best mode contemplated for carrying out this disclosure, but that the disclosure will include all embodiments falling within the scope of the appended claims.

1. A sealable fuel vapor storage and recovery system, comprising:
a fuel tank;
a vapor storage device comprising a chamber containing fuel vapor adsorbent material and having a first end including first and second openings and a second end including a third opening, the first end and the chamber and the second end defining a linear flow path therebetween;
the first opening of the vapor storage device fluidly connected to a vent opening in the fuel tank;
the second opening of the vapor storage device fluidly connected to a purge line fluidly connectable to an induction system via a purge valve;
the third opening fluidly connected to a vent valve in fluid communication with atmospheric air;
the vent valve selectively controllable to one of an open position and a closed position; and
the vent valve operative to seal the third opening of the vapor storage device when controlled in the closed position and having a cross-sectional area substantially equal to a cross-sectional area of the third opening of the vapor storage device when controlled in the open position.

2. The system of claim 1, further comprising the purge valve configured to seal the second opening of the vapor storage device when in a closed position.

3. The system of claim 1, wherein the vent opening in the fuel tank is configured to vent fuel vapor in the fuel tank during a refueling event.

4. The system of claim 3, wherein the induction system comprises an air induction system of an internal combustion engine.

5. The system of claim 4, further comprising a control module configured to control the vent valve to an open position during the refueling.

6. The system of claim 5, further comprising the control module configured to control the purge valve to the open position and the vent valve to the open position during operation of the internal combustion engine.

7. Fuel vapor storage and recovery system, comprising:
a fuel tank including a filler neck having a sealable cap, the filler neck fluidly connected to an on-board refueling vapor recovery tube fluidly connected to a vapor storage device;
the vapor storage device comprising a chamber containing fuel vapor adsorbent material and having a first end including first and second openings and a second end including a third opening, the first end and the chamber and the second end defining a linear flow path therebetween;
the first opening fluidly connected to a vent opening in the fuel tank;
the second opening fluidly connected to a purge line fluidly connected to a purge valve;
the third opening fluidly connected to a first end of a vent valve selectively controllable in a closed position to fluidly seal the third opening;
a second end of the vent valve fluidly connected to atmospheric air; and
the second end of the vent valve configured to have a cross-sectional area substantially equal to a cross-sectional area of the third opening of the vapor storage device when the vent valve is controlled to an open position.

8. The system of claim 7, wherein the vent valve comprises a single-stage sealable valve selectively controllable to one of the open position and a closed position.

9. Fuel vapor storage and recovery system, comprising:
a fuel tank including a filler neck having a sealable cap and a vent tube fluidly connected to a vapor storage device;
the vapor storage device including
a first end of the vapor storage device including a first opening fluidly connected to the vent tube of the fuel tank and including a second opening fluidly connected to a controllable purge valve,
a second end of the vapor storage device including a third opening fluidly connectable to atmospheric air via a controllable vent valve,
the controllable vent valve configured to fluidly seal the third opening when controlled to a closed position,
the controllable vent valve fluidly connected to atmospheric air when the vent valve is controlled to an open position,
a chamber containing a fuel vapor adsorbent material, and
the first end, the chamber, and the second end defining a linear flow path through the vapor storage device.

10. The system of claim 9, wherein the second opening is fluidly connected to an induction system via the controllable purge valve only when the controllable purge valve is controlled to an open position.

11. The system of claim 10, wherein the controllable purge valve is configured to fluidly seal the second opening when controlled to a closed position.

12. The system of claim 11, wherein the induction system comprises an induction system of an internal combustion engine.

13. The system of claim 12, further comprising a control module configured to control the vent valve to the open position during a fueling event.

14. The system of claim 13, wherein the vent valve comprises a single-stage high-flow sealable valve selectively controllable to one of the open position and the closed position.

15. The system of claim 14, further comprising the vent valve having a cross-sectional area substantially equal to a cross-sectional area of the third opening of the vapor storage device when the vent valve is controlled to the open position.

16. The system of claim 12, further comprising a control module configured to control the controllable purge valve to the open position and control the vent valve to the open position when operating the internal combustion engine.
